(19) United States
(12) Patent Application Publication
(10) Pub. No.: US 2024/0367128 A1
(43) Pub. Date: Nov. 7, 2024

(54) AUTOCLAVE VACUUM SYSTEM AND FILTER

(71) Applicant: Wichita State University, Wichita, KS (US)

(72) Inventors: Joshua Goertz, Wichita, KS (US); Waruna Seneviratne, Wichita, KS (US); Brett Brummer, Wichita, KS (US); Prabodha Jayathilaka, Wichita, KS (US)

(21) Appl. No.: 18/654,347

(22) Filed: May 3, 2024

Related U.S. Application Data
(60) Provisional application No. 63/499,882, filed on May 3, 2023.

(51) Int. Cl. B01J 3/04; B01J 3/00

(52) U.S. Cl. CPC B01J 3/04; B01J 3/002; B01J 2219/00162

(57) ABSTRACT

An autoclave vacuum system uses two vacuum sources to selectively impart a vacuum. In an exemplary embodiment, the vacuum sources are different types, wherein the first vacuum source is a vacuum pump, and the second source is a Venturi vacuum. The autoclave vacuum system uses a valve system for controlling whether the first and/or second vacuum sources are fluidly coupled to the vacuum enclosure. The valve system allows the autoclave vacuum system to assume a plurality of different configurations chosen such that a constant desired pressure is attained in the autoclave. The valve system may be triggered by a control system configured to recognize and act upon autoclave requirements such as temperature, pressure, duration of use, and number of cycles.

### CROSS-REFERENCE TO RELATED APPLICATION

This application claims priority to U.S. Provisional Patent Application No. 63/499,882, which is hereby incorporated by reference in its entirety.

### FIELD

The present disclosure generally relates autoclaves for composite manufacturing, and more specifically, to a vacuum system for an autoclave.

### BACKGROUND

Autoclaves are used in the manufacture composite parts, most commonly thermoset composite parts. Autoclaves use pressure and/or heat to create (e.g., cure) the part. Some composite manufacturing processes employ vacuum compaction. The process involves placing a layup of composite material inside a vacuum bag before placing it in the autoclave. The vacuum bag serves as a containment system and is sealed around the layup to create an airtight environment. A vacuum pump is then used to extract air from the vacuum bag, creating a negative pressure environment. This negative pressure environment compresses the composite material and removes any trapped air or voids within it. The autoclave simultaneously applies pressure and heat to the vacuum bag, which further compresses the composite material while curing it. The resulting composite structure has improved mechanical properties, increased structural integrity, and is free of voids. The use of vacuum compaction in combination with the autoclave process ensures that the composite material is compacted uniformly, and that the resulting composite structure is strong and durable.

### SUMMARY

Therefore, an aspect of the detailed description is to remove air and debris from the interior of an autoclave.

Generally, the vacuum system comprises a first and second vacuum sources which are fluidly connected to a vacuum enclosure in an autoclave. To connect these members, multiple types of plumbing is used. Such plumbing comprises lines, hoses, fittings, connectors ports, manifolds, valves, and filters.

In an exemplary embodiment, the first vacuum source is a vacuum pump, and the second vacuum source is a venturi vacuum. The first and second vacuum source may operate either together or in series in order to maintain a certain vacuum on the vacuum enclosure. The first and second vacuum source is controlled by a valve system. The valve system comprises a plurality of valves which permit and block fluid communication between the first and second vacuum source. Further, a plurality of different vacuum configurations can be obtained through the adjustment of said valve system. The plurality of different vacuum configurations is configured to apply the best seal on the vacuum enclosure due to certain temperature and pressure parameters.

The vacuum system also may comprise a control system configured to control and operate the autoclave. The control system comprising a controller which is communicatively coupled to a heating system, pressure system and the vacuum system. The control system may allow a user interface to allow the user or operator to control the autoclave and the aforementioned systems. The control system may additionally include temperature sensors configured to switch a vacuum source in use from the first vacuum source to the second vacuum source dependent on a sensed temperature value.

Other aspects will be in part apparent and in part pointed out hereinafter.

### BRIEF DESCRIPTION OF THE DRAWINGS

FIG. 1 is a schematic illustration of an autoclave according to one embodiment of the present disclosure;

FIG. 2 is an image of a vacuum system of the autoclave of FIG. 1;

FIG. 3 is another image of the vacuum system;

FIG. 4 is a schematic illustration of a Venturi vacuum of the autoclave of FIG. 1;

FIG. 5 is a schematic block diagram of an exemplary control system for the autoclave of FIG. 1;

FIG. 6 is a schematic illustration of an autoclave according to another embodiment of the present disclosure;

FIG. 7 is a perspective of a filter of the autoclave of FIG. 6;

FIG. 8 is a cross-sectional perspective of the filter;

FIG. 9 is a cross-section of the filter;

FIG. 10 is an exploded view of the filter; and

FIG. 11 is a perspective of the filter's connection to a part and to the autoclave.

Corresponding reference characters indicate corresponding parts throughout the drawings.

### DETAILED DESCRIPTION

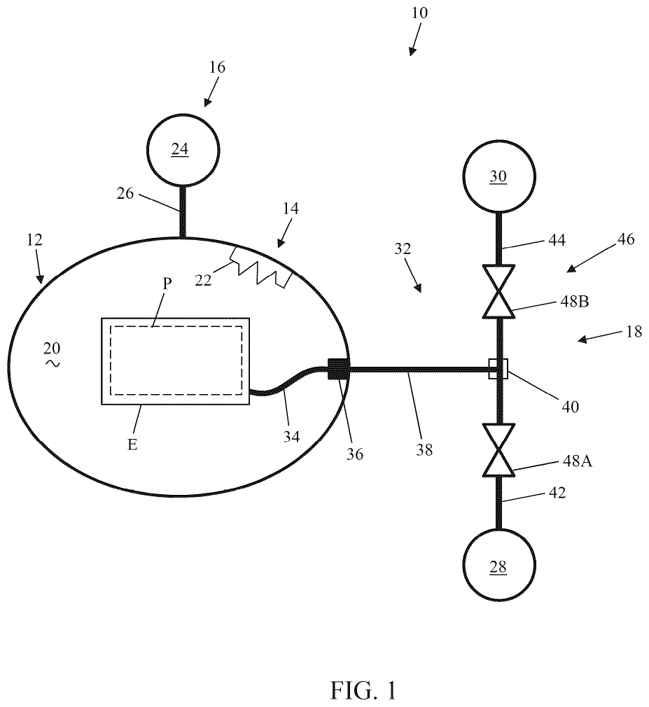

Referring to FIGS. 1-5, one embodiment of an autoclave for creating a part P is generally indicated at reference numeral 10. The autoclave 10 is used in the manufacturing process of the part P to cure or form the composite materials, or any other suitable materials, making up the part. In general, the materials forming the part P are placed in a vacuum enclosure E, such as a plastic bag or the like, which is then placed in the autoclave 10. The autoclave 10 then uses pressure and/or heat to cure the materials and form the part P. The vacuum enclosure E is completely enclosed such that a vacuum can be formed therein during the curing process.

The autoclave 10 includes a pressure vessel 12, a heating system 14, a pressure system 16, and a vacuum system 18. The pressure vessel 12 has an interior 20 sized and shaped to receive one or more parts P therein (only one part is shown in FIG. 1). The pressure vessel 12 includes a vessel body (not shown) and a lid or door (not shown) for accessing the interior 20. The pressure vessel 12 is made of rigid and strong material, such as steel or the like, to withstand the pressure and/or heat applied to the part P. The heating system 14 generates the heat needed to cure the part P. The heating system 14 is configured to control the temperature within the interior 20 of the pressure vessel 12. Specifically, the heating system 14 heats the air (broadly, environment) within the interior 20 of the pressure vessel 12. The heating system 14 may comprise one or more heating elements 22, such as electrical resistance heating elements, arranged to heat the interior 20 of the pressure vessel 12. For example, the one or more heating elements 22 may be disposed in or otherwise in thermal contact with the interior 20 of the pressure vessel 12. Other forms and/or configurations of heating systems may be used and are within the scope of the present disclosure. Preferably, the heating system 20 can heat the interior 20 of the pressure vessel 12 to any temperature up to about 1000° F. (538° C.), such as within the inclusive range of about 450-1000° F. (232-538° C.), or more preferably within the inclusive range of about 450-800° F. (232-427° C.). The pressure system 16 (e.g., a positive pressure system) generates pressure that compacts the part P together as it cures in the autoclave 10. The pressure system 16 is configured to control the pressure within the interior 20 of the pressure vessel 12. Specifically, the pressure system 16 increases the pressure within the interior 20 of the pressure vessel 12. The pressure system 16 may include one or more compressors 24 (broadly, one or more positive pressure sources) fluidly connected to the interior 20 of the pressure vessel 12, such as by one or more lines or conduits 26. The pressure system 16 may also include on or more vents (not shown) for releasing the pressure to return the pressure within the interior 20 of the pressure vessel 12 to atmospheric pressure. Preferably, the pressure system 16 can pressurize the interior 20 of the pressure vessel 12 to any pressure up to about 200 psi, such as within the inclusive range of about 30-100 psi. Other forms and/or configurations of pressure systems may be used and are within the scope of the present disclosure.

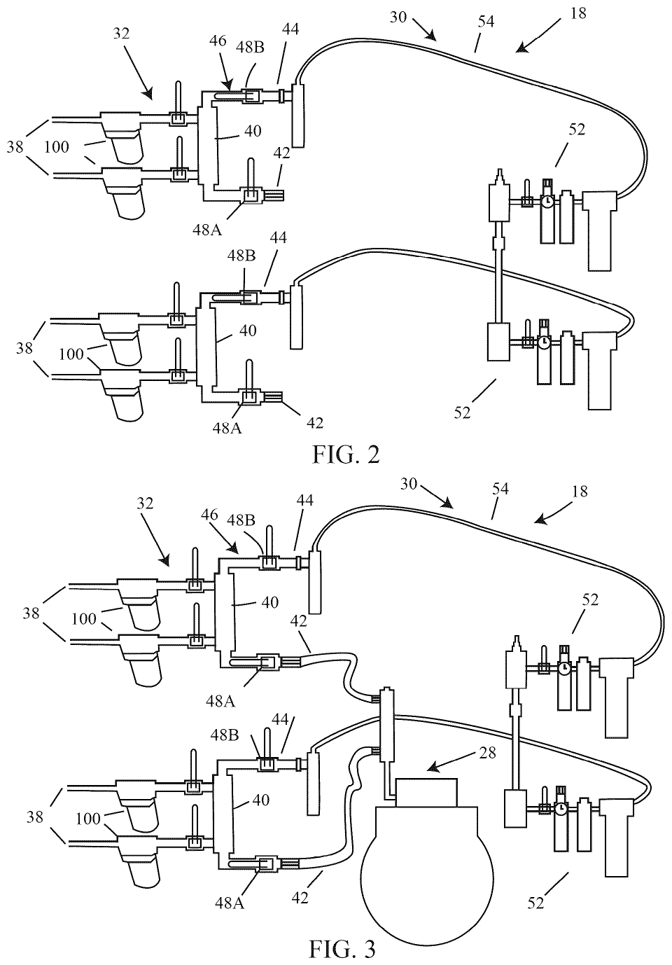

The vacuum system 18 removes air and other debris from the vacuum enclosure E. The vacuum system 18 is configured to apply a vacuum to the enclosure E while it contains the part P in the interior 20 of the pressure vessel. The vacuum system 18 of the present disclosure includes two vacuum sources, a first vacuum source 28 and a second vacuum source 30, for generating the vacuum. The first and second sources 28, 30 can selectively impart a vacuum in the enclosure E while it contains the part P in the interior 20 of the pressure vessel 12. It is understood that the autoclave 10 may contain several parts P, each in their own vacuum enclosure E, with the first and second vacuum sources 28, 30 fluidly connected to each vacuum enclosure. The first and second vacuum sources 28, 30 are different (e.g., separate and distinct from one another). In the illustrated embodiment, the first and second vacuum sources 28, 30 are of different types. The first vacuum source 28 is a vacuum pump (broadly, a first type of vacuum source), as shown in FIG. 3, and the second vacuum source 30 is a Venturi vacuum (broadly, a second type of vacuum source), as shown in FIGS. 2-4. In other embodiments, the first and second vacuum sources may be of the same type. Other types of vacuum sources are within the scope of the present disclosure. In one embodiment, the first and second vacuum sources 28, 30 may operate simultaneously to generate and maintain the vacuum during the autoclave cycle. In another embodiment, the first and second vacuum sources may operate one after the other to generate and maintain the vacuum during the autoclave cycle. For example, the first vacuum source 28 may operate for a first portion of the autoclave cycle and then the second vacuum source may operate for a second portion of the autoclave cycle, or vice versa, to generate and maintain the vacuum over the course of the autoclave cycle.

The first and second vacuum sources 28, 30 are fluidly connected to the vacuum enclosure E containing the part P. The vacuum system 18 includes plumbing 32 fluidly connecting the vacuum sources 28, 30 to the vacuum enclosure E. The plumbing 32 is coupled to the first and second vacuum sources 28, 30. The plumbing 32 may include a vacuum enclosure port or vacuum enclosure connector for connecting to a corresponding port or connector of the vacuum enclosure E to fluidly couple the vacuum enclosure to the plumbing. The plumbing 32, in general, may include conduits or lines, hoses, fittings, connectors, ports, manifolds, valves, filters, and/or other components for fluidly connecting the vacuum enclosure E to the first and second vacuum sources 28, 30. In the embodiment illustrated in FIG. 1, the plumbing 32 includes a flexible hose 34, a vacuum port 36, a vacuum source conduit 38, a T-fitting 40, a first source vacuum conduit 42, and a second source vacuum conduit 44. The flexible hose 34 extends from the vacuum enclosure E to the vacuum port 36 in the interior 20 of the pressure vessel 12. The vacuum source conduit 38 extends from the vacuum port 36 to the T-fitting 40, which branches toward the respective first and second pressure sources 28, 30. The first source vacuum conduit 42 extends from the T-fitting 40 to the first vacuum source 28 and the second source vacuum conduit 44 extends from the T-fitting to the second vacuum source 30.

The plumbing 32 also includes a valve system 46 for controlling whether the first and/or second pressure sources 28, 30 are fluidly coupled to the vacuum enclosure E. The valve system 46 includes one or more valves for individually selectively permitting and blocking fluid communication between the first and second pressure sources 28, 30. In the illustrated embodiment, the valve system 46 includes a first pressure source valve 48A for selectively permitting and blocking fluid communication between the first pressure source 28 and the vacuum enclosure E and a second pressure source valve 48B for selectively permitting and blocking fluid communication between the second pressure source 30 (independent of the first pressure source). The first pressure source valve 48A is positioned along the first source vacuum conduit 42 and the second pressure source valve 48B is positioned along the second source vacuum conduit 44. Other configurations of the valve system are within the scope of the present disclosure. For example, instead of two valves 48A, 48B, a single 3-way valve at the T-fitting 40 could be used.

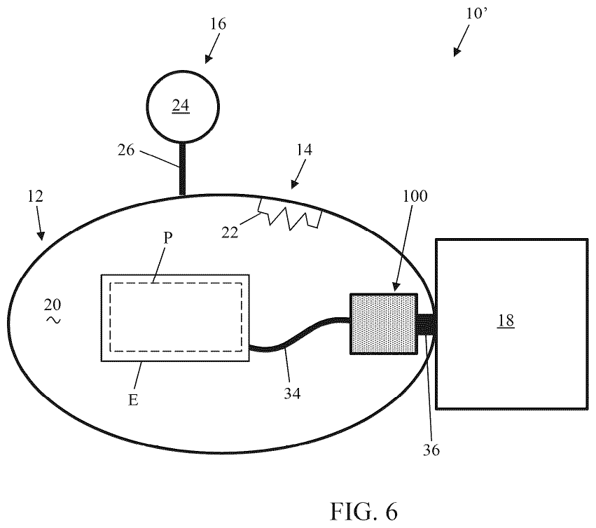

The valve system 46 is configurable in different configurations (e.g., first, second, third, and fourth configurations). In a first configuration, the valve system 46 enables the first vacuum source 28 to be in fluid communication with the vacuum enclosure E and inhibits or blocks the second vacuum source 30 from being in fluid communication with the vacuum enclosure, as shown in FIG. 3. In a second configuration, the valve system 46 inhibits the first vacuum source 28 from being in fluid communication with the vacuum enclosure E and enables the second vacuum source 30 to be in fluid communication with the vacuum enclosure, as shown in FIG. 2. In a third configuration, the valve system 46 enables the first and second fluid sources 28, 30 to be in fluid communication with the vacuum enclosure E. In a fourth configuration, the valve system 46 inhibits the first and second fluid sources 28, 30 from being in fluid communication with the vacuum enclosure E. The one or more valves (e.g., vales 48A, 48B) of the valve system 46 are operable to configure the valve system in the different configurations. For example, in the illustrated embodiment, the first pressure source valve 48A is opened and the second pressure source valve 48B is closed to place the valve system 46 in the first configuration, the first pressure source valve is closed and the second pressure source valve is opened to place the valve system in the second configuration, the first and second pressure source valves are opened to place the valve system in the third configuration, and the first and second pressure source valves are closed to place the valve system in the fourth configuration. In one embodiment, each valve of the valve system 46 may be operatively coupled to a prime mover 49 (FIG. 5), such as an electric motor, a solenoid, a linear actuator, or the like, for selectively opening and closing the respective valves to place the valve system in the desired configuration.

Other configurations of the plumbing 32, such as other ways of fluidly connecting the first and second vacuum sources 28, 30 to the vacuum enclosure E, are within the scope of the present disclosure. For example, as shown in FIGS. 2 and 3, components of the plumbing 32 (e.g., the vacuum source conduit 38, the T-fitting 40, the first and second source vacuum conduits 42, 44, the first and second pressure source valves 48A, 48B, etc.) are duplicated to expand the capacity of the vacuum system 18 to be able to connect with multiple vacuum enclosures E. In the embodiments illustrated in FIGS. 2 and 3, the vacuum system 18 includes four vacuum source conduits 38, each of which generally corresponds to one vacuum enclosure E (e.g., vacuum port 36) in the interior 20 of the pressure vessel 12 (for a total of four vacuum enclosures containing four different parts P being cured at the same time). Accordingly, it is understood the capacity of the vacuum system 18 can be modified to accommodate any number of vacuum enclosures E. In some embodiments, two or more vacuum source conduits 38 can be fluidly coupled to the same vacuum enclosure E, such as for a vacuum enclosure containing a very large part P. In the embodiments illustrated in FIGS. 2 and 3, the T-fittings 40 act as manifolds (broadly, are manifolds) which consolidate multiple vacuum source conduits 38, such that a single set of first and second pressure source valves 48A, 48B can control the fluid communication between the vacuum sources 28, 30 and multiple vacuum source conduits (broadly, multiple vacuum enclosures E).

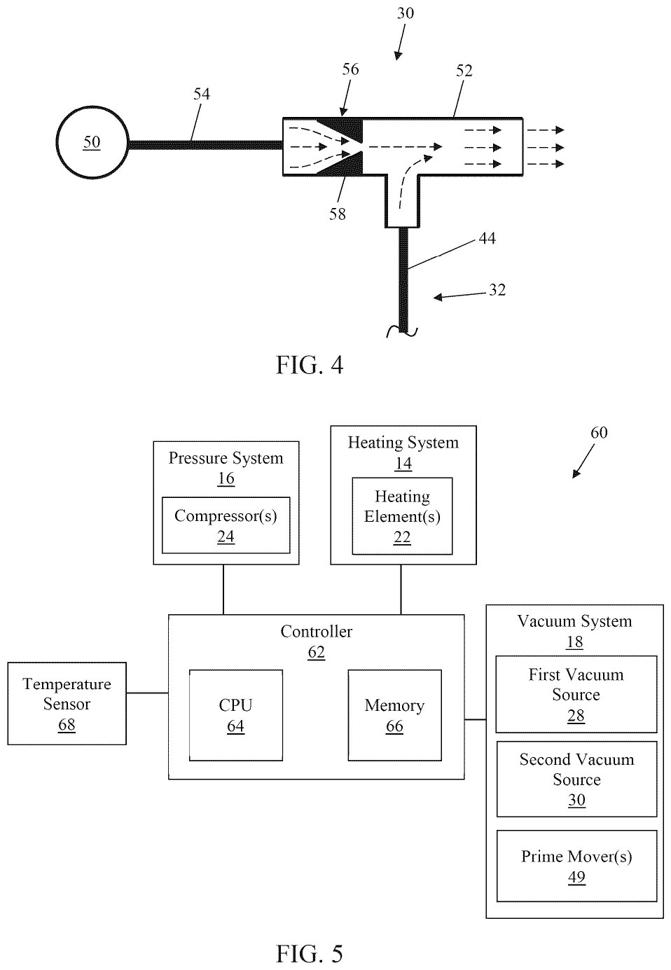

Referring to FIG. 4, the second vacuum source 30 (e.g., the venturi vacuum) comprises a positive pressure source 50 (e.g., a compressor), a venturi vacuum generator 52, and a gas supply conduit 54 (broadly, plumbing including conduits, fittings, connectors, ports, manifolds, valves, filters, etc.) extending between and delivering pressurized gas (e.g., air) from the positive pressure source to the venturi vacuum generator. The positive pressure source 50 may be a positive pressure source of the pressure system 16 or may be a separate positive pressure source. The venturi vacuum generator 52 includes a venturi 56 for generating the vacuum (e.g., vacuum or negative pressure). The second source vacuum conduit 44 is fluidly coupled to the venturi vacuum generator 52, downstream (e.g., immediately downstream) of the venturi 56 such that the venturi generates the vacuum in the second source vacuum conduit 44. The venturi 56 includes a venturi nozzle 58 that presents a restriction to gas flowing from the gas supply conduit 54. As the gas flows through the restriction, the gas creates the vacuum at the downstream end of the venturi nozzle 58. The connection between the second source vacuum conduit 44 and the venturi vacuum generator 52 is aligned with the downstream end of the venturi nozzle 58 such that the vacuum generated at the downstream end of the venturi nozzle is communicated through the second source vacuum conduit 44 (and thereby the rest of the plumbing 32 to the vacuum enclosure E). The venturi vacuum generator 52 vents the gas flow to the surrounding environment.

Referring to FIG. 5, the autoclave 10 has a control system 60 configured to control and operate the autoclave. The control system 60 includes a controller 62 (broadly, a computer) having a CPU or processor 64 and RAM or memory 66 (broadly, non-transitory computer-readable storage medium), such as a hard drive (e.g., a hard disk drive, a solid state drive, etc.). The controller 62 provides the computing engine that drives the operation of the autoclave 10. Broadly, the memory 66 includes (e.g., stores) processor-executable instructions for controlling the operation of the processor 64. The instructions embody one or more functional aspects of the autoclave 10 and its components (e.g., heating system 14, pressure system 16, vacuum system 18, etc.) as described herein, with the processor 64 executing the instructions to perform said one or more functional aspects.

The controller 62 is communicatively coupled (wired or wirelessly) to the various components of the autoclave 10, such as the heating system 14, the pressure system 16, vacuum system 18, to control and/or operate these components. For example, the controller 62 can activate the pressure system 16 to pressurize the interior 20 of the pressure vessel to a desired pressure, operate the heating system 14 to heat the interior of the pressure vessel to a desired temperature, and/or operate the vacuum system 18 to apply the vacuum to the one or more vacuum enclosures E. The control system 60 may include a user interface (not shown) to allow the user or operator to control the autoclave 10. For example, the user interface may receive user inputs (e.g., temperature settings, pressure settings, duration settings, start autoclave cycle, end autoclave cycle, etc.) and displaying information to the user.

The control system 60 can include one or more temperature sensors 68 for sensing a temperature of the gas of the autoclave 10. The controller 62 is configured to switch between the first and second vacuum sources 28, 30 depending upon the sensed temperature. In particular, the controller 62 is configured to arrange the valve system 46 (via the prime movers 49) in one of the configurations based on the temperature sensed by the temperature sensor. For example, the controller 62 can arrange the valve system 46 in the first or second configuration based on the temperature sensed by the temperature sensor. In this manner, the control system 60 can switch between the first vacuum source 28 and the second vacuum source 30 during the autoclave cycle. The autoclave 10 operates at different temperatures depending on the materials forming the part P. For example, if the part P comprises thermoset materials, the heating system 14 will generally heat the interior 20 of the pressure vessel 12 to about 350° F. (177° C.). If the part P comprises thermoplastic materials, the heating system 14 will general heat the interior 20 of the pressure vessel 12 to about 750° F.-800° F. (399° C.-427° C.). The higher temperatures required during the autoclave cycle for thermoplastic materials can cause serious damage to certain components of the autoclave 10, such as the first pressure source 28 (e.g., the vacuum pump). Should the vacuum enclosure E break, puncture, or otherwise leak during the autoclave cycle, the hot gas within the interior 20 of the pressure vessel 12 will flow into the vacuum enclosure (via the pressure within the interior of the pressure vessel applied by the pressure system 16 and/or the vacuum applied by the vacuum system 18), through the plumbing 32 and to the first pressure source 28, potentially damaging it. Due to the rate at which the hot gas will flow through the components, the hot gas may reach the first pressure source 28 in less than a few seconds. It is estimated that about 4% of vacuum enclosures E have some sort of failure (e.g., puncture, break, bad seal with tape, tape fails, etc.) during the autoclave cycle which can result in the hot gas entering the vacuum system 18. By employing the two vacuum sources 28, 30, the autoclave 10 of the present disclosure is able to switch between the vacuum sources during the autoclave cycle so that if a leak in the vacuum enclosure E occurs, the hot gas in the interior 20 of the pressure vessel 12 does not reach, and therefore damage, the first pressure source. Because the second vacuum source 30 (specifically, the venturi vacuum generator 52) does not include any of the high temperature sensitive components that the first pressure source 28 (e.g., vacuum pump) does, the second pressure source 30 is able to withstand the hot gas and continue to operate even if it comes into contact with the hot gas. Therefore, unlike conventional autoclaves with only a vacuum pump which may be damaged and stop applying a vacuum should the vacuum enclosure E develop a leak (which may also lead to the part P failing to be properly formed during the autoclave cycle), the autoclave 10 of the present disclosure is able to switch over the second pressure source 30 from the first pressure source 28 to prevent the hot gas from damaging the first pressure source and to ensure that the vacuum system 18 continues to draw a vacuum (potentially enabling the part P to be properly formed during the autoclave cycle) in the event the vacuum enclosure fails.

In one example, the controller 62 monitors the temperature sensed by the temperatures sensor 68 during the autoclave cycle and operates the valve system 46 to switch from the first configuration (where the first vacuum source 28 is generating the vacuum) to the second configuration (where the second vacuum source 30 is generating the vacuum) when the temperature reaches a threshold temperature (broadly, is greater than or equal to the threshold temperature). In one embodiment, the threshold temperature is about 450° F. (232° C.) for a pressurized autoclave cycle (e.g., when the pressure system 16 pressurizes the interior 20 of the pressure vessel 12) and is about 550° F. for a non-pressurized autoclave cycle (e.g., when the interior 20 of the pressure vessel 12 remains generally at atmospheric pressure). In another embodiment, the temperature sensor 68 is arranged to detect the temperature within the interior 20 of the pressure vessel 12. In this embodiment, the controller 60 automatically switches from the first vacuum source 28 to the second vacuum source 30 based on the temperature of the interior 20, independent of any failure of the vacuum enclosure. In one embodiment, the temperature sensor 68 is arranged to detect the temperature of the gas within the plumbing 32 (broadly, vacuum system 18). For example, the temperature sensor 68 can be arranged to detect the temperature of the gas within the T-fitting 40. In this embodiment, the controller 60 automatically switches from the first vacuum source 28 to the second vacuum source 30 based on the failure of vacuum enclosure E—i.e., when the hot gas from the interior 20 reaches the temperature sensor 68 by flowing through the vacuum enclosure and along the plumbing 32. In another embodiment, where both the first and second vacuum sources 28, 30 simultaneously generate the vacuum, the controller 60 automatically fluidly disconnects (e.g., closes the first vacuum source valve 48A) when the hot gat reaches the threshold temperature.

A method of operating the autoclave 10 to cure a part P will now be described. The part P, specifically the materials that will make up the part P, are placed in a vacuum enclosure E. The vacuum enclosure E, with the part P contained therein, is then placed in the interior 20 of the autoclave 10. The vacuum enclosure E is connected to the vacuum system 18. The user attaches one end of the hose 34 to the vacuum enclosure E and the opposite end of the hose to the vacuum port 36 of the vacuum system 18. The user closes the door to the pressure vessel 12, sealing the vacuum enclosure E and the part P in the interior. The autoclave begins an autoclave cycle during which it imparts pressure and/or heat to cure the part P. During the autoclave cycle, the vacuum system 18 applies the vacuum to the enclosure E. The vacuum may be applied continuously or intermittently. In one example, applying the vacuum includes applying a first vacuum with the first pressure source 28 and applying a second vacuum with the second pressure source 30. In one example, the second vacuum is applied after the first vacuum. In one example, the second vacuum is applied immediately after the first vacuum such that the enclosure is continuously under vacuum. Preferably, the temperature of the autoclave 10 is monitored (via the temperature sensor 68) by the controller 62 during the autoclave cycle and the controller switches from the first vacuum (e.g., first vacuum source 28) to the second vacuum (e.g., second vacuum source 30) based on the temperature monitored. For example, the controller 62 switches from the first vacuum to the second vacuum when the monitored temperature reaches (broadly, is greater than or equal to) the threshold temperature. As mentioned herein, the monitored temperature may be a temperature of the interior 20 of the autoclave 20 or of the plumbing 32 of the vacuum system 18. During the autoclave cycle, the heating system 14 may also heat the interior 20 of the autoclave 10. For example, the heating system 14 can heat the interior 20 to the threshold temperature. The heating can occur simultaneously with or separately from the application of the vacuum by the vacuum system 18. In addition, during the autoclave cycle, the pressure system 16 may also pressurize the interior 20 of the autoclave 10. For example, the pressure system 16 may pressurize the interior 20 to a threshold pressure, based on the materials forming the part P. The pressurization can occur simultaneously with or separately from the application of the vacuum by the vacuum system 18 and/or heating by the heating system 14. For example, in one autoclave cycle, the heating system 14, the pressure system 16, and the vacuum system 18 all operate from the beginning of the autoclave cycle to the end of the autoclave cycle. Other orders and sequences of operation of the autoclave 10 are within the scope of the present disclosure.

Referring to FIG. 6, another embodiment of an autoclave according to the present disclosure is generally indicated at reference numeral 10′. The autoclave 10′ of autoclave of FIG. 6 is generally analogous to the autoclave of FIGS. 1-5 and, thus, for ease of description, where similar, analogous, or identical parts are used, identical reference numerals are used. Accordingly, unless clearly stated or indicated otherwise, the descriptions regarding the autoclave 10 of FIGS. 1-5 also apply to the autoclave 10′ of FIG. 6.

In this embodiment, the vacuum system 18 (broadly, the autoclave 10) includes a filter 100 for filtering the fluid (e.g., air) that is removed from the vacuum enclosure E by the vacuum system. The fluid may contain debris, such as pieces of the material forming the part P, resin particles, etc., that can damage the components (e.g., pressure sources) of the vacuum system 18 if not removed. Further, the debris can build up over time, forming a block in the vacuum system 18. The vacuum system 18 is arranged to apply the vacuum to the part P through the filter 100. Although one filter 100 is shown in FIG. 6, it is understood that the vacuum system 18 may have multiple filters, such as one filter coupled to each vacuum port 36 of the vacuum system. In other words, one filter 100 for each vacuum enclosure E.

The filter 100 is disposed in the interior 20 of the pressure vessel 12. Conventional filters are not able to operate in the harsh conditions inside an autoclave. But as explained more fully below, the filter 100 of the present disclosure is capable of operating inside an autoclave, even inside an autoclave used at thermoplastic consolidation temperatures. The inventors believe that it is undesirable to locate the debris filter outside the autoclave because, as compared with an internal location inside the autoclave, an external location is further downstream from the source of potentially damaging debris (e.g., the resin system of the part P). While a filter located outside the autoclave may be able to prevent debris from reaching the vacuum source of the vacuum system, the debris still has to travel through a large length of vacuum system plumbing before reaching an external filter. As a result, the debris can affect more of the plumbing, leading to higher maintenance and repair costs. For example, resin drawn into the vacuum system can cause failure of any plumbing surface it touches if not promptly removed. As compared with cleaning or replacing a short length of plumbing extending from the enclosure E to the internal filter 100 of the present disclosure, the additional work required to clean or replace the entire length of resin-contaminated plumbing extending from the enclosure E to an external filter adds substantially to maintenance and repair costs. By placing the filter 100 in the interior 20 of the pressure vessel 12, near the vacuum enclosure E, the filter is able to catch and remove the debris before the debris leaves the interior, preventing the debris from building up in the downstream conduits.

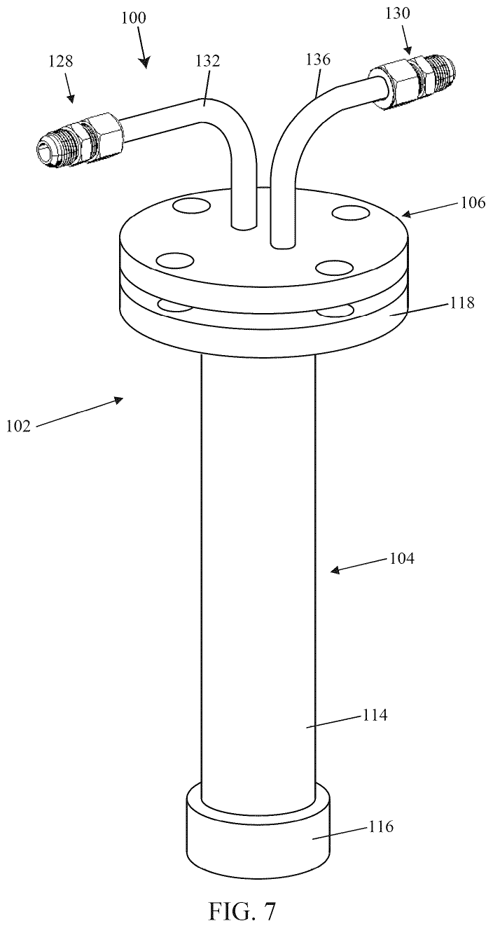

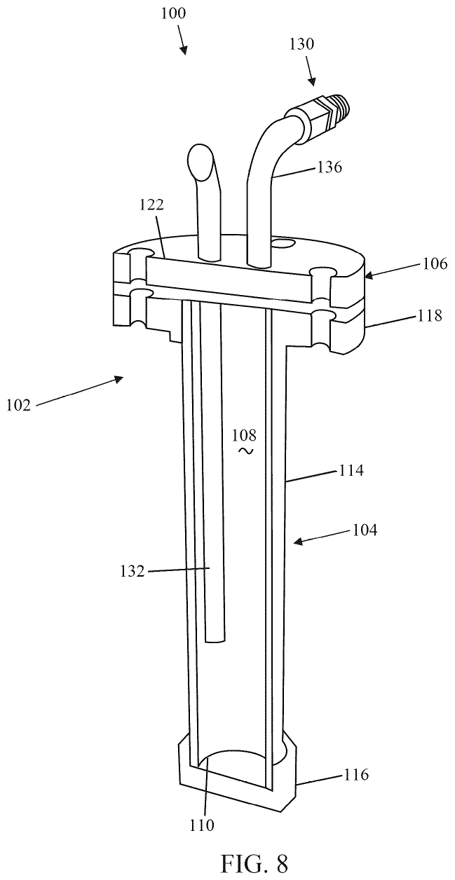

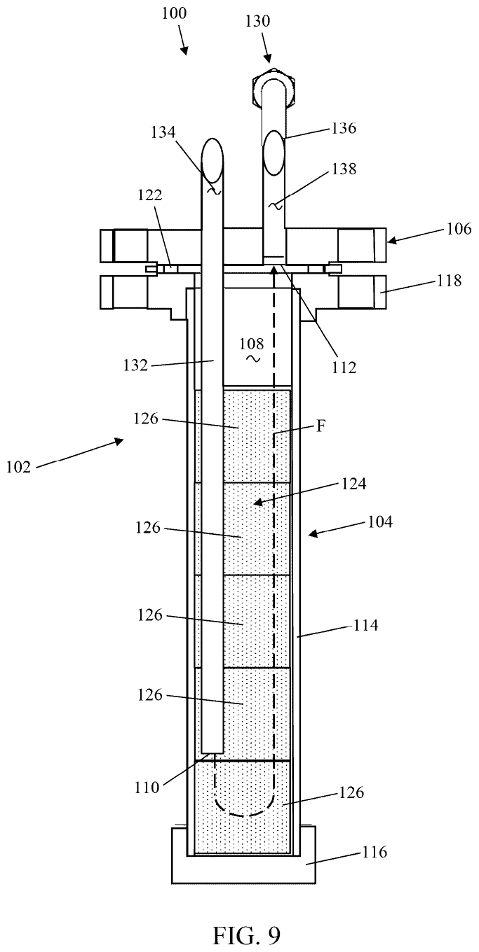

Referring to FIGS. 7-10, the filter 100 includes a rigid housing 102 having a main body 104 and a lid or cap 106. The rigid housing 102 has a filter interior 108 (broadly, interior). The lid 106 and main body 104 bound the filter interior 108. The lid 106 is releasably coupled to the main body 104 for accessing the filter interior 108. The filter interior 108 has an inlet 110 through which fluid enters the filter interior when the vacuum is applied by the vacuum system 18 (broadly, the autoclave 10′) and an outlet 112 through which fluid leaves the filter interior when the vacuum is applied by the vacuum system. Preferably, the inlet 110 and outlet 112 are arranged such that the fluid has to make at least one turn (e.g., a 90-degree turn) as the fluid flows F in the filter interior 108 from the inlet to the outlet. This facilitates the removal of the debris from the fluid. In the illustrated embodiment, the fluid turns 180 degrees as the fluid flows F from the inlet 110 to the outlet 112 (FIG. 9). The filter interior 108 includes an upper portion and a lower portion. In the illustrated embodiment, the inlet 110 is disposed in the lower portion of the filter interior 108 and the outlet 112 is disposed in the upper portion of the filter interior. This arrangement results in the fluid traveling a long distance through the filter, increasing the contact the fluid has with the filter media (described below), resulting in a greater chance the filter media captures the debris in the fluid flow. In the illustrated embodiment, the main body 104 includes a cylindrical wall 114 and an end cap 116 attached to the cylindrical wall. The cylindrical wall 114 and end cap 116 bound the interior 108. The main body 104 includes a flange 118 for attaching the lid 106 to the main body. The lid 106 and flange 118 each have fastener openings through which fasteners 120 (e.g., bolts with washers and nuts) can extend to couple the lid and flange together. The filter 100 includes a gasket 122 disposed between the lid 106 and the flange 118 (broadly, the main body 104). The gasket 122 is arranged to form a fluid tight seal between the lid 106 and the main body 104 when the lid is coupled to the main body. Preferably, the gasket 122 is a high temperature gasket, such as a spiral wound metal gasket, for withstanding the high temperatures and pressures the filter 100 will experience within the interior 20 of the autoclave 10. Other configurations of the housing are within the scope of the present disclosure. For example, other ways of securing the lid to the main body are within the scope of the present disclosure.

The filter 100 includes filter media 124 disposed in the interior 108 of the rigid housing 104 (FIG. 9). The filter media 124 is arranged to be fluidly disposed between the inlet 110 and the outlet 112 of the interior 108. This way the fluid has to flow along a path F through the filter media 124 as the fluid moves in the interior 108, from the inlet 110 toward the outlet 112. The filter media 124 is constructed to withstand the high temperatures (e.g., inclusive range of about 450-1000° F. (232-538° C.)) within the interior 20 of the autoclave 10 and the vacuum applied by the vacuum system 18. In one embodiment, the filter media 128 comprises (e.g., is made of) a metallic mesh, such as a stainless steel mesh, although other suitable types of filter media such as carbon filters are within the scope of the present disclosure. In the illustrated embodiment, the metallic mesh is a metallic (e.g., stainless steel) sponge or pad 126, such as stainless steel wool. In the illustrated embodiment, the filter media comprises a plurality (broadly, one or more) metallic sponges 126 that generally fill the interior 108. As needed, the lid 106 can be periodically removed from the main body 104 to clean the interior 108 and replace the filter media 124.

The filter 100 includes a hose or inlet port 128 and an autoclave or outlet port 130. The hose port 128 is disposed in the interior 20 of the autoclave 10 and is coupled to the hose 34 extending to the vacuum enclosure E. Connecting the hose 34 directly to the filter 100, via the hose port 128, ensures any debris will be caught by the filter before reaching the more permanent components (e.g., the rigid conduits 38, 42, 44, fittings 40, valves 48, etc.) of the vacuum system 18 that require substantial disassembly for cleaning or replacement. The hose port 128 is fluidly coupled to the inlet 110 of the interior 108. The filter 100 includes a first conduit 132 defining an inlet passageway 134 extending between the hose port 128 and the inlet 110 that fluidly couples the hose port to the inlet. In the illustrated embodiment, the hose port 128 is supported by the lid 106. The hose port 128 is attached to one end of the first conduit 132 and the first conduit extends through and is attached to the lid 106. The end of the first conduit 132 opposite the hose port 128 defines the inlet 110. The autoclave port 120 is also disposed in the interior 20 of the autoclave 10. The autoclave port 130 is coupled to the vacuum port 36 within the interior 20 of the pressure vessel 12. Accordingly, autoclave port 120 enables the filter 100 to be easily installed in an existing autoclave by simply connecting the autoclave port 130 to the existing vacuum port in the autoclave. The autoclave port 130 is fluidly coupled to the outlet 112 of the interior 108. The filter 100 includes a second conduit 136 defining an outlet passageway 138 extending between the outlet 112 and the autoclave port 130 that fluidly couples the autoclave port to the outlet. In the illustrated embodiment, the autoclave port 130 is supported by the lid 106. The autoclave port 130 is attached to one end of the second conduit 136 and the second conduit is attached to the lid 106. The end of the second conduit 136 opposite the autoclave port 130 defines the outlet 112. In the illustrated embodiment, the outlet 112 is generally flush with a bottom surface of the lid 106.

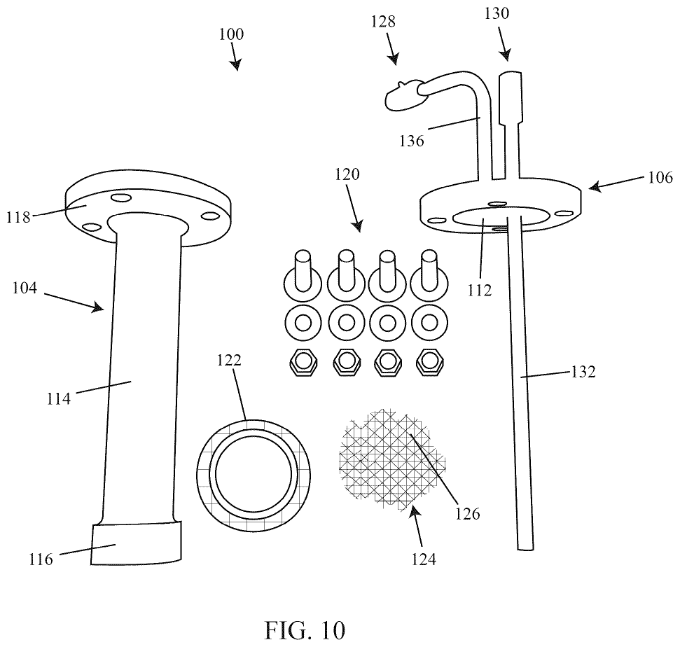

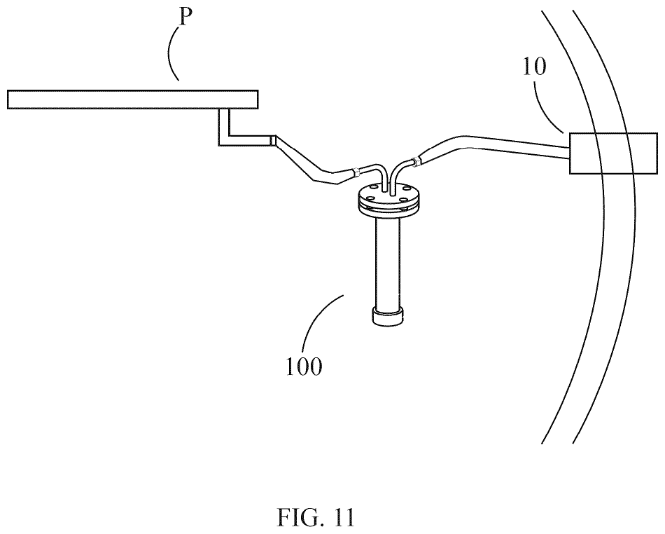

The filter 100 is constructed to withstand the high temperatures and the pressures imparted by the autoclave 10. As mentioned above, the gasket 122 and filter media 124 are made of materials able to withstand the high temperatures and pressures. In addition, the other components (e.g., rigid housing 102, ports 128, 130, conduits 132, 136, etc.) of the filter 100 are also constructed to withstand the pressures (e.g., inclusive range of about 30-200 psi) and the high temperatures (e.g., inclusive range of about 450-1000° F. (232-538° C.), or more specifically the inclusive range of about 450-800° F. (232-427° C.)) within the interior 20 of the autoclave 10. For example, in the illustrated embodiment, the rigid housing 102, the ports 128, 130, the fasteners 120, and the conduits 132, 136 are made of stainless steel (as shown in FIG. 10), although other suitable materials are within the scope of the present disclosure. Further these components have a sufficient bulk or stiffness (e.g., thickness) to withstand the pressures imparted by the autoclave 10. Conventional filters are not able to withstand the temperatures and/or pressures within an autoclave and would be destroyed (e.g., buckle, crush, crack, split, melt, burn, etc.) if placed within an autoclave.

In operation, the autoclave 10′ of FIG. 6 with the filter 100 operates in generally the same manner as the autoclave 10 of FIGS. 1-5 described above, except that the user uses the hose port 128 of the filter to connect the vacuum enclosure E to the vacuum system 18. The user attaches one end of the hose 34 to the vacuum enclosure E and the opposite end of the hose to the hose port 128 of the filter 100. If not already done, the user would then connect the filter 100 to the vacuum port 36 of the autoclave 10. The user would couple the autoclave port 130 to the vacuum port 36. During the autoclave cycle, the vacuum is applied through the filter 100. The fluid drawn from the vacuum enclosure E flows through the hose 34 and through the filter 100. As the fluid flows F through the filter 100, the filter media 124 captures and retains debris in the fluid before the debris reaches the components of the vacuum system 18 downstream of the filter. Additionally, as seen in FIG. 11, the filter 100 is configured to be connected inline between the part P and the autoclave 10. In an alternative embodiment, the filter 100 may be directly connected to the part P allowing the filter to travel with the part into the autoclave. The filter 100 traveling with the part P allows for differing lifespans of filters depending on what part is being developed.

Although described in connection with an exemplary computing system environment, embodiments of the aspects of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the exemplary operating environment. Examples of well-known computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the disclosure.

Embodiments of the aspects of the disclosure may be implemented with processor-executable instructions. The processor-executable instructions may be organized into one or more processor-executable components or modules on a tangible processor readable storage medium. Aspects of the disclosure may be implemented with any number and organization of such components or modules. For example, aspects of the disclosure are not limited to the specific processor-executable instructions or the specific components or modules illustrated in the figures and described herein. Other embodiments of the aspects of the disclosure may include different processor-executable instructions or components having more or less functionality than illustrated and described herein.

The order of execution or performance of the operations in embodiments of the aspects of the disclosure illustrated and described herein is not essential, unless otherwise specified. That is, the operations may be performed in any order, unless otherwise specified, and embodiments of the aspects of the disclosure may include additional or fewer operations than those disclosed herein. For example, it is contemplated that executing or performing a particular operation before, contemporaneously with, or after another operation is within the scope of aspects of the disclosure.

In view of the above, it will be seen that several advantageous results are obtained.

Having described the disclosure in detail, it will be apparent that modifications and variations are possible without departing from the scope of the disclosure defined in the appended claims.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. An autoclave for curing a part, the autoclave comprising:
a pressure vessel having an interior sized and shaped to receive the part therein;
a heating system configured to control the temperature within the interior of the pressure vessel, the heating system including a heating element arranged to heat the interior;
a pressure system configured to control the pressure within the interior of the pressure
vessel;
a first vacuum source configured to place the part under vacuum when the part is disposed in the interior of the pressure vessel; and
a second vacuum source, different than the first vacuum source, configured to place the part under vacuum when the part is disposed in the interior of the pressure vessel.

2. The autoclave of claim 1, wherein the first vacuum source is of a first type of vacuum source and the second vacuum source is of a second type of vacuum source different than the first type of vacuum source.

3. The autoclave of claim 2, wherein the first vacuum source comprises a vacuum pump and the second vacuum source comprises a venturi vacuum.

4. The autoclave of claim 1, further comprising plumbing coupled to the first and second vacuum sources, the plumbing is configured to couple to a vacuum enclosure containing the part to fluidly couple the first and second vacuum sources to the part.

5. The autoclave of claim 4, wherein the plumbing includes a valve system having a first configuration where the valve system enables the first vacuum source to be in fluid communication with the vacuum enclosure and inhibits the second vacuum source from being in fluid communication with the vacuum enclosure, and a second configuration where the valve system inhibits the first vacuum source from being in fluid communication with the vacuum enclosure and enables the second vacuum source to be in fluid communication with the vacuum enclosure.

6. The autoclave of claim 5, wherein the valve system comprises one or more valves for configuring the valve system in the first and second configurations.

7. The autoclave of claim 5, further comprising a temperature sensor and a controller, the controller being configured to arrange the valve system in the first configuration or the second configuration based on a temperature sensed by the temperature sensor.

8. The autoclave of claim 7, wherein the temperature sensor is arranged to detect the temperature within the plumbing.

9. The autoclave of claim 7, wherein the temperature sensor is arranged to detect the temperature within the interior of the pressure vessel.

10. The autoclave of claim 7, wherein the controller is configured to change the valve system from the first configuration to the second configuration when the temperature sensed by the temperature sensor is greater than or equal to about 450° F. (232° C.).

11. A method for curing a part in an autoclave, the method comprising:
placing the part in a vacuum enclosure;
placing the vacuum enclosure, with the part therein, in the interior of the autoclave;
connecting the vacuum enclosure to a vacuum system of the autoclave;
applying a vacuum to the part using the vacuum system, the vacuum system including a first vacuum source and a second vacuum source different than the first vacuum source.

12. The method of claim 11, wherein said applying the vacuum includes applying a first vacuum with the first vacuum source and applying a second vacuum with the second vacuum source.

13. The method of claim 12, wherein said applying the vacuum includes applying the second vacuum after the first vacuum.

14. The method of claim 13, further comprising monitoring a temperature of the autoclave and switching from the first vacuum to the second vacuum based on the temperature monitored.

15. The method of claim 14, wherein said switching from the first vacuum to the second vacuum occurs when the temperature is greater than or equal to about 450° F. (232° C.).

16. The method of claim 15, wherein the temperature is of the interior of the autoclave.

17. The method of claim 11, wherein the first vacuum source is of a first type of vacuum source and the second vacuum source is of a second type of vacuum source different than the first type of vacuum source.

18. The method of claim 17, wherein the first vacuum source comprises a vacuum pump and the second vacuum source comprises a venturi vacuum.

19. The method of claim 11, further comprising heating the interior of the autoclave simultaneously with said applying the vacuum.

20. The method of claim 19, further comprising pressurizing the interior of the autoclave simultaneously with said applying the vacuum.
